(19) United States
(12) Patent Application Publication
(10) Pub. No.: US 2026/0194851 A1
(43) Pub. Date: Jul. 9, 2026

(54) FIXING DEVICE AND IMAGE FORMING APPARATUS

(71) Applicant: CANON KABUSHIKI KAISHA, Tokyo (JP)

(72) Inventor: SHOJI YAMAMOTO, Kanagawa (JP)

(21) Appl. No.: 19/437,007

(22) Filed: Dec. 30, 2025

(30) Foreign Application Priority Data
Jan. 8, 2025 (JP) 2025-002925

(51) Int. Cl. G03G 15/00; G03G 15/20; G03G 21/16

(52) U.S. Cl. CPC G03G 15/80; G03G 15/2032; G03G 15/2064; G03G 21/1633; G03G 21/1647; G03G 2221/1639; G03G 2221/1654; G03G 2221/169

(57) ABSTRACT

In a fixing device including a power supply connector connected to a heater so as to sandwich a heater holder and the heater; and a pressure change mechanism capable of switching between a first state in which a pressure applied to a fixing nip portion is high and a second state in which the pressure is low, the heater holder has a connector cover integrally molded therewith and configured to accommodate the power supply connector, and the connector cover includes an extension portion that enters a space between a power supply cable that extends from the power supply connector and a movable portion of the pressure change mechanism, the extension portion overlapping with the power supply cable and the movable portion when viewed from a direction perpendicular to a planar portion of the heater.

### BACKGROUND

### Field of the Technology

The present disclosure relates to a fixing device mounted on an electrophotographic image forming apparatus.

### Description of the Related Art

In an electrophotographic image forming apparatus, a fixing device (fixing unit) adopting an on-demand fixing method is known. Image fixing is performed on a sheet onto which an unfixed image has been transferred, by pressurization by a roller nip of a pressure roller pair included in the fixing device and by heating with a heater. The fixing device may include a pressure release mechanism (pressure change mechanism) for switching the nip pressure of the pressure roller pair, and include a power supply cable for supplying electric power to the heater.

In the fixing device described in Japanese Patent Application Publication No. H11-345680, a power supply cable is routed near the operating region of the pressure release mechanism. There is a concern that, when the power supply cable enters the operating region of the pressure release mechanism, the cable may become broken due to being pinched.

### SUMMARY

The present disclosure is directed to provide a technology capable of restricting an approach of a cable to a pressure change mechanism with a simple configuration.

In order to address the problems described above, according to some embodiments of the present disclosure, a fixing device includes a fixing belt, which is cylindrical; a heater, which is plate-shaped and disposed in an interior space of the fixing belt; a heater holder disposed in the interior space of the fixing belt and configured to hold the heater over a longitudinal direction of the heater; a power supply connector for supplying electric power to the heater, the power supply connector being connected to the heater so as to sandwich the heater holder and the heater; a pressure roller configured to come into contact with an outer peripheral surface of the fixing belt, the pressure roller sandwiching the fixing belt together with the heater, thereby forming a fixing nip portion between the pressure roller and the fixing belt; and a pressure change mechanism capable of switching between a first state in which a pressure applied to the fixing nip portion is high and a second state in which the pressure is low, wherein in the fixing nip portion, a toner image formed on a recording material while conveying the recording material is fixed to the recording material, wherein the heater holder has a connector cover integrally molded therewith and configured to accommodate the power supply connector, and wherein the connector cover includes an extension portion that enters a space between a power supply cable that extends from the power supply connector and a movable portion of the pressure change mechanism, the extension portion overlapping with the power supply cable and the movable portion in a case of viewing from a direction perpendicular to a planar portion of the heater.

Furthermore, in order to address the problems described above, according to some embodiments of the present disclosure, a fixing device includes a fixing belt, which is cylindrical; a heater, which is plate-shaped and disposed in an interior space of the fixing belt; a heater holder disposed in the interior space of the fixing belt and configured to hold the heater over a longitudinal direction of the heater; a power supply connector for supplying electric power to the heater, the power supply connector being connected to the heater so as to sandwich the heater holder and the heater; a pressure roller configured to come into contact with an outer peripheral surface of the fixing belt, the pressure roller sandwiching the fixing belt together with the heater, thereby forming a fixing nip portion between the pressure roller and the fixing belt; and a pressure change mechanism capable of switching between a first state in which a pressure applied to the fixing nip portion is high and a second state in which the pressure is low, wherein in the fixing nip portion, a toner image formed on a recording material while conveying the recording material is fixed to the recording material, wherein the heater holder has a connector cover integrally molded therewith and configured to accommodate the power supply connector, wherein the connector cover includes a holding form for holding a power supply cable that extends from the power supply connector, and wherein the holding form holds the power supply cable so as to restrict movement of the power supply cable in a direction approaching a movable portion of the pressure change mechanism.

Furthermore, in order to address the problems described above, according to some embodiments of the present disclosure, an image forming apparatus is configured to form an image on a recording material, including an image forming portion configured to form an unfixed image on the recording material; a fixing portion configured to fix the unfixed image onto the recording material; and a door configured to be movable between an open position at which an interior of the image forming apparatus is opened to an outside, and a closed position at which the interior is closed, wherein the fixing portion is the fixing device of the present disclosure, and wherein the pressure change mechanism is a link mechanism coupled to the door, the link mechanism comprising a mechanism capable of performing an operation of switching between the first state and the second state of the pressure change mechanism in interlock with an opening/closing operation of the door.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view of a fixing unit according to some embodiments.

FIG. 1B is a perspective view of the fixing unit as viewed from an angle different from that of FIG. 1A according to some embodiments.

FIG. 2 is a sectional view of an image forming apparatus according to some embodiments.

FIG. 3 is a sectional view of a heating unit and a pressure rotating member according to some embodiments.

FIG. 4 is a sectional view of the fixing unit according to some embodiments.

FIG. 5 is an exploded perspective view of the fixing unit according to some embodiments.

FIG. 6A is a sectional view of the fixing unit in a first state according to some embodiments.

FIG. 6B is a sectional view of the fixing unit in a pressure-released state according to some embodiments.

FIG. 7 is an exploded perspective view of the fixing unit according to some embodiments.

FIG. 8 is a schematic diagram illustrating a layout of heater electrodes according to some embodiments.

FIG. 9A is a perspective view of a heater connector in a second state according to some embodiments.

FIG. 9B is a perspective view of the heater connector in a mounted state according to some embodiments.

FIG. 10A is a perspective view of a heater holder according to some embodiments.

FIG. 10B is a perspective view of the heater holder as viewed from an angle different from that of FIG. 10A according to some embodiments.

FIG. 11A is a perspective view of a heater holder according to some embodiments.

FIG. 11B is a perspective view of the heater holder as viewed from an angle different from that of FIG. 11A according to some embodiments.

### DESCRIPTION OF THE EMBODIMENTS

Modes for carrying out this disclosure are now described in detail by way of examples based on various exemplary embodiments, features, and aspects with reference to the drawings. However, the dimensions, materials, shapes, relative arrangements, and the like of components described in these embodiments are to be appropriately changed depending on the configuration of the apparatus to which the disclosure is applied and various conditions. That is, the scope of this disclosure is not intended to be limited to the following embodiments. Furthermore, although a plurality of features is described in the embodiments, not all of the plurality of features are necessarily essential to the disclosure, and the plurality of features may be optionally combined. Moreover, in the accompanying drawings, the same or similar components are denoted by the same reference symbols, and redundant descriptions are omitted.

### Embodiment 1

A first embodiment of the present disclosure is described in detail based on the drawings.

### Image Forming Apparatus

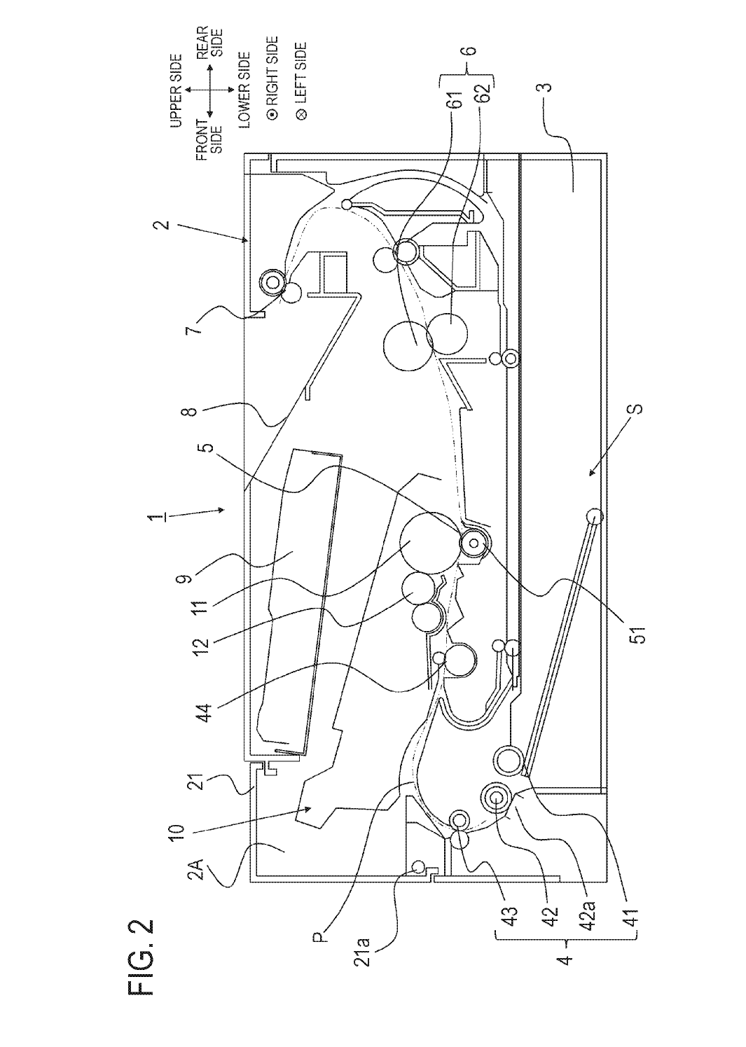

FIG. 2 is a sectional view illustrating the schematic configuration of a laser beam printer 1, which is an example of an electrophotographic image forming apparatus (image forming apparatus). Note that, in the following description, the left side in FIG. 2 is defined as the front side of the laser beam printer 1, and the right side in FIG. 2 is defined as the rear side of the laser beam printer 1. The near side of the drawing sheet is defined as the right side of the laser beam printer 1, and the far side of the drawing sheet is defined as the left side of the laser beam printer 1. Furthermore, the upper side and the lower side in FIG. 2 are defined as the upper side and the lower side of the laser beam printer 1, respectively. When the laser beam printer 1 is used while being placed on a horizontal surface serving as a normally assumed installation surface, the up-down direction matches the direction of gravity.

As illustrated in FIG. 2, the laser beam printer 1 includes an apparatus main body 2 and a process cartridge 10. The process cartridge 10 is detachably installed in the apparatus main body 2. The apparatus main body 2 includes a sheet feed tray 3, a sheet feed portion 4, a conveyance passage P, an image forming portion 5, a fixing unit 6, a sheet discharge portion 7, a sheet discharge tray 8, a laser scanner 9, and the like. Meanwhile, the process cartridge 10 includes a photosensitive drum 11, a developing roller 12 serving as a developer bearing member, and the like.

Note that the apparatus main body 2 includes an opening/closing door 21, which serves as an opening/closing member, for covering an opening portion 2A provided to allow the process cartridge 10 to be attached and detached. The opening/closing door 21 is supported to be pivotable around a pivot shaft 21a, and is configured to be movable between a closed position at which the opening portion 2A is closed and an open position at which the opening portion 2A (the interior of the apparatus main body 2) is opened.

The sheet feed portion 4 includes a sheet feed roller 41, a separation roller 42, a separation pad 42a, and a conveyance roller pair 43. Based on a print start signal, a sheet S, which serves as a recording material, stored in the sheet feed tray 3 is fed to the conveyance passage P by the sheet feed portion 4 and conveyed toward the image forming portion 5 through a registration roller pair 44.

When the sheet S is conveyed to a predetermined position, an image formation start signal is issued, and an image forming process is started. The photosensitive drum 11 driven to rotate by a drive source (motor), which is not shown, is uniformly charged to a predetermined potential by a charging unit, which is not shown. The surface of the photosensitive drum 11 after being charged is exposed by the laser scanner 9 based on the image information, and the electric charge in the exposed portion is removed to form an electrostatic latent image. The toner inside the process cartridge 10 is borne on the developing roller 12 and supplied to the photosensitive drum 11 in accordance with the electrostatic latent image, thereby developing the latent image. With this, the latent image is visualized as a toner image on the photosensitive drum 11.

The image forming portion 5 includes the process cartridge 10 and a transfer roller 51 disposed to face the photosensitive drum 11 included in the process cartridge 10. When the sheet S conveyed by the registration roller pair 44 reaches the image forming portion 5 and passes through the nip portion between the photosensitive drum 11 and the transfer roller 51, a voltage is applied to the transfer roller 51 from the apparatus main body 2, and the toner image on the photosensitive drum 11 is transferred onto the sheet S as an unfixed image (unfixed toner image). Thereafter, the sheet S onto which the toner image has been transferred is conveyed to the fixing unit 6 serving as a fixing portion, which includes a heating unit 61 and a pressure rotating member 62. When the sheet S passes through the nip portion between the heating unit 61 and the pressure rotating member 62, the unfixed image transferred onto the sheet S is heated and pressurized, thereby being fixed to the surface of the sheet S. The sheet S to which the toner image has been fixed is discharged to the sheet discharge tray 8 through the sheet discharge portion 7.

### Fixing Unit

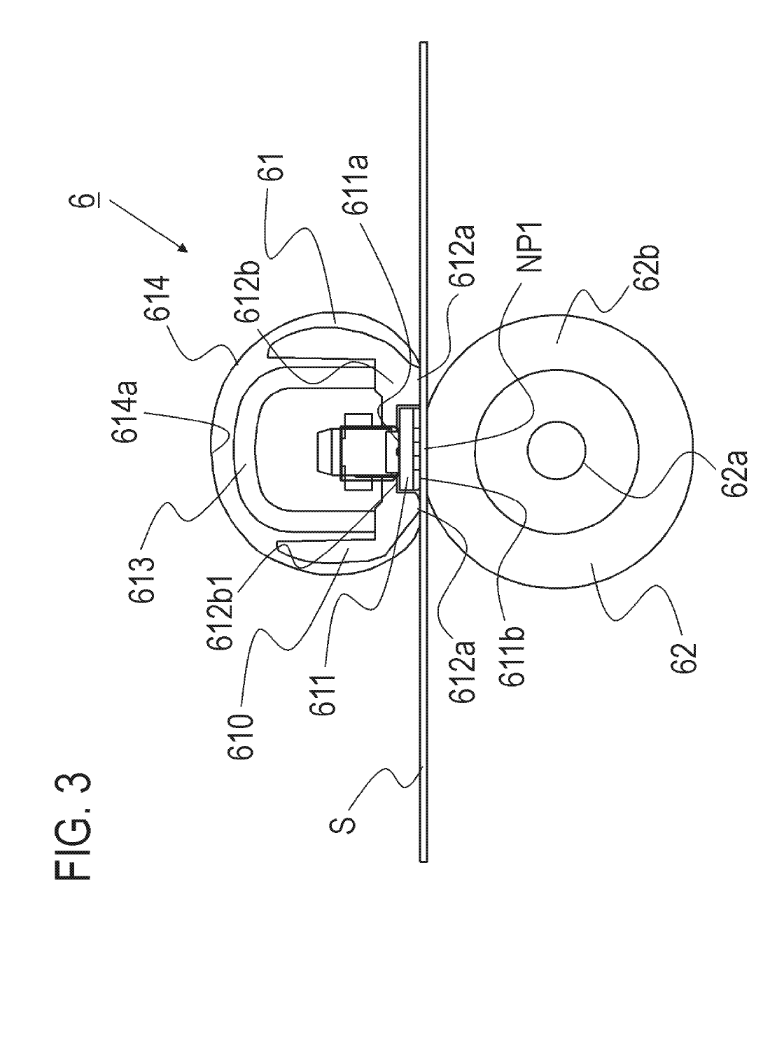

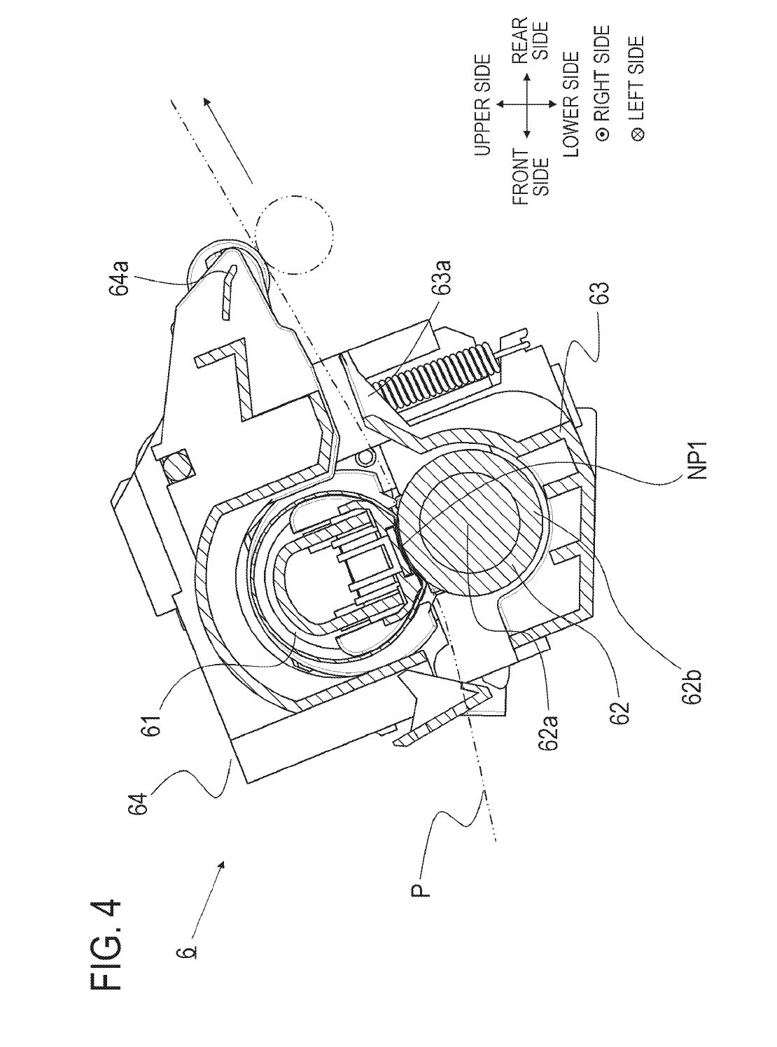

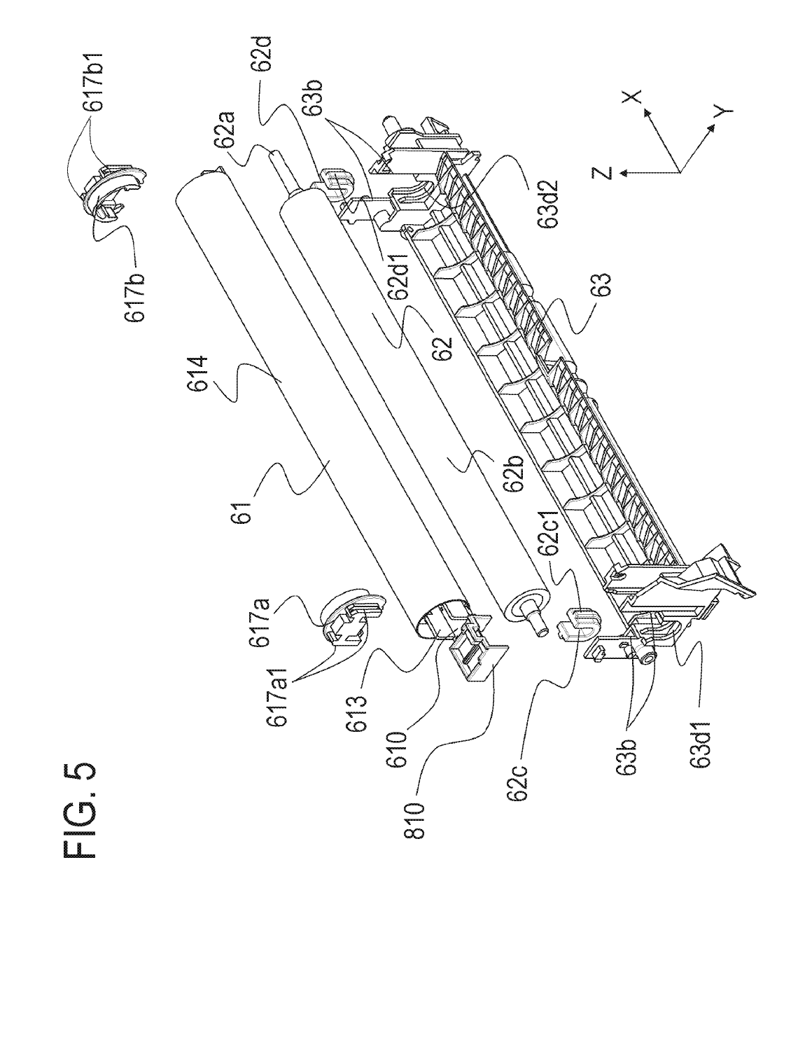

The specific configuration of the fixing unit 6 (fixing device) is described using FIGS. 3 to 5. FIG. 3 is a sectional view of the heating unit 61 and the pressure rotating member 62. FIG. 4 is a sectional view of the fixing unit 6. FIG. 5 is an exploded perspective view of the fixing unit 6.

As illustrated in FIG. 3, the heating unit 61 included in the fixing unit 6 includes a heater 611, a holder 610, a stay 613, and a belt 614. The heater 611 has a flat plate shape that extends in the left-right direction, and has a first surface 611a and a second surface 611b on the opposite side of the first surface 611a. The first surface 611a is supported by the holder 610. Note that, hereinafter, the longitudinal direction of the heater 611 (the left-right direction of the laser beam printer 1) is also referred to as "longitudinal direction", and the width direction of the heater 611 orthogonal to the longitudinal direction is also referred to as "width direction".

The holder 610 is a heater holder configured to hold the heater 611 over the longitudinal direction of the heater 611. The holder 610 is formed by a resin having heat resistance, such as PPS or liquid crystal polymer, and has a guide surface 612a and a support wall 612b. The guide surface 612a guides the belt 614 while being in contact with an inner peripheral surface 614a of the belt 614. The support wall 612b has a support surface 612b1 configured to support the heater 611. The support surface 612b1 of the support wall 612b is in abutment against the first surface 611a of the heater 611. The stay 613 is a member configured to support the holder 610. The stay 613 is formed by bending a plate material with greater rigidity than the holder 610, for example, a steel plate with a plate thickness of 1.6 mm, into a substantially U-shape.

The belt 614 is an endless (cylindrical) fixing belt having heat resistance and flexibility, and examples thereof include one in which a metal sleeve of stainless steel or the like is coated with a fluororesin, and one in which a polyimide resin, a silicone rubber, a fluororesin, and the like are laminated. On the inner side of the belt 614 (the interior space of the belt 614 surrounded by the belt 614), the heater 611, the holder 610, and the stay 613 are disposed, and the belt 614 is configured to rotate around these. The inner peripheral surface 614a of the belt 614 comes into contact with the second surface 611b of the heater 611.

### Pressure Mechanism

As illustrated in FIGS. 3 to 5, the pressure rotating member 62 is a pressure roller including a shaft 62a made of metal and a roller 62b including an elastic body that surrounds the shaft 62a. The pressure rotating member 62 comes into contact with the outer peripheral surface of the belt 614. The pressure rotating member 62 is pressed against the heater 611 through the belt 614. The pressure rotating member 62 sandwiches the belt 614 together with the heater 611, thereby forming, as a fixing nip portion, a nip portion NP1 for nipping the sheet S between the pressure rotating member 62 and the belt 614 and heating and pressurizing the sheet S. That is, the pressure rotating member 62 heats and pressurizes the sheet S together with the heater 611 in the nip portion NP1.

The pressure rotating member 62 is configured to be driven to rotate by a drive force transmitted from the drive source included in the image forming apparatus 1. When the pressure rotating member 62 is driven to rotate, the belt 614 passively rotates by a frictional force with the pressure rotating member 62 or the sheet S sandwiched in the nip portion NP1. With this, the sheet S onto which the toner image has been transferred is conveyed between the pressure rotating member 62 and the heated belt 614, and the toner image is thus thermally fixed.

As illustrated in FIG. 4, the fixing unit 6 includes a lower frame 63 configured to support the heating unit 61 and the pressure rotating member 62, and an upper frame 64 located above the lower frame 63 and configured to cover the heating unit 61.

The upper frame 64 includes, on the downstream side of the heating unit 61 and the pressure rotating member 62 in the sheet conveyance direction, an upper sheet guide 64a configured to guide the upper surface of the sheet S conveyed along the conveyance passage P. The lower frame 63 includes, at a position downstream of the heating unit 61 and the pressure rotating member 62 in the sheet conveyance direction, a lower sheet guide 63a configured to guide the lower surface of the sheet S conveyed along the conveyance passage P.

The conveyance passage P in the fixing unit 6 extends in a direction along a substantially front-rear direction and is inclined upward as the conveyance passage P goes from the front side toward the rear side. That is, the sheet conveyance direction in the fixing unit 6 is the direction along the substantially front-rear direction.

Note that, in the present configuration, the lower frame 63 and the upper frame 64 are formed by non-conductive mold members.

As illustrated in FIG. 5, the lower frame 63 supports the heating unit 61 and the pressure rotating member 62. The lower frame 63 includes a pair of rails 63b at each end portion in the longitudinal direction. The rails 63b support, through transmission members 617a and 617b configured to transmit a pressure to the stay 613, the holder 610 such that the holder 610 is movable in a thickness direction (Z direction) orthogonal to the longitudinal direction (X direction) and the width direction (Y direction). The thickness direction orthogonal to the longitudinal direction and the width direction is hereinafter also simply referred to as "thickness direction".

The rails 63b are columnar portions that extend from the lower frame 63 in the thickness direction (Z direction). The paired rails 63b face each other in the width direction (Y direction). The opposing surfaces of the rails 63b are engaged with groove portions 617a1 and 617b1 provided in the transmission members 617a and 617b, respectively. Note that, in the present embodiment, the rails 63b are the columnar portions that extend in the thickness direction, but the rails 63b may have any shape capable of supporting the holder 610 such that the holder 610 is movable in the thickness direction, and are not limited to the shape of the present embodiment.

Furthermore, the pressure rotating member 62 has both longitudinal end portions of the shaft 62a made of metal rotatably held by the lower frame 63 through bearings 62c and 62d. At this time, a protruding portion 62c1 provided on the bearing 62c is fitted into a recessed portion 63d1 provided in the lower frame 63, thereby determining the position of the bearing 62c. Similarly, a protruding portion 62d1 provided on the bearing 62d is fitted into a recessed portion 63d2 provided in the lower frame 63, thereby determining the position of the bearing 62d.

Note that, in the present configuration, the protruding portions 62c1 and 62d1 are provided on the bearings 62c and 62d, and the recessed portions 63d1 and 63d2 are provided in the lower frame 63, but the protrusion-and-recess relationship is not limited to this. Furthermore, the means for fixing the bearings 62c and 62d to the lower frame 63 is not limited to the protrusion-and-recess form.

Note that, in the present embodiment, the pressure rotating member 62 has a configuration including the shaft 62a and the roller 62b, but the configuration is not limited to this. The pressure rotating member 62 may have a configuration including a pressure belt configured to be pressed against a heat roller by an elastic member.

### Pressure Release Mechanism

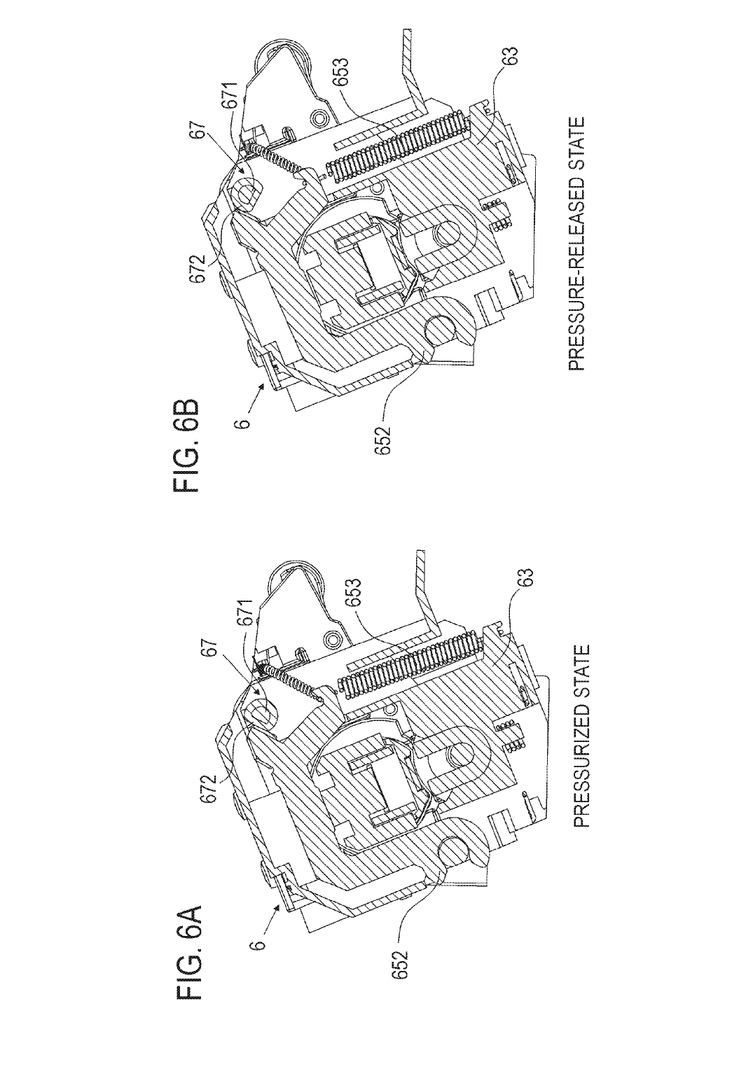

FIG. 6A is a sectional view of the fixing unit 6 in a pressurized state (first state). FIG. 6B is a sectional view of the fixing unit 6 in a pressure-released state. As illustrated in FIG. 6A and FIG. 6B, the fixing unit 6 further includes a pressure release mechanism 67 for releasing a nip pressure in the nip portion NP1 between the heating unit 61 and the pressure rotating member 62. The pressure release mechanism 67 is configured as a pressure change mechanism to be capable of switching between a pressurized state in which a pressure applied to the nip portion NP1 is high and a pressure-released state (second state) in which the pressure is low.

The pressure release mechanism 67 includes a camshaft 671 and a cam 672. The lower frame 63 supports a pressure spring 653 and supports a pressure arm 652 and the cam 672 in a pivotable manner. The pressure spring 653 has one end coupled to the lower frame 63 and the other end coupled to the pressure arm 652. The pressure spring 653 is configured to generate a predetermined biasing force between the lower frame 63 and the pressure arm 652 with respect to pivoting of the pressure arm 652 relative to the lower frame 63.

The cam 672 is located at each end portion of the lower frame 63 in the longitudinal direction. Since the structure on one side of the pressure release mechanism 67 in the longitudinal direction and the structure on the other side thereof are substantially the same, the structure on the one side in the longitudinal direction is mainly described below as a representative.

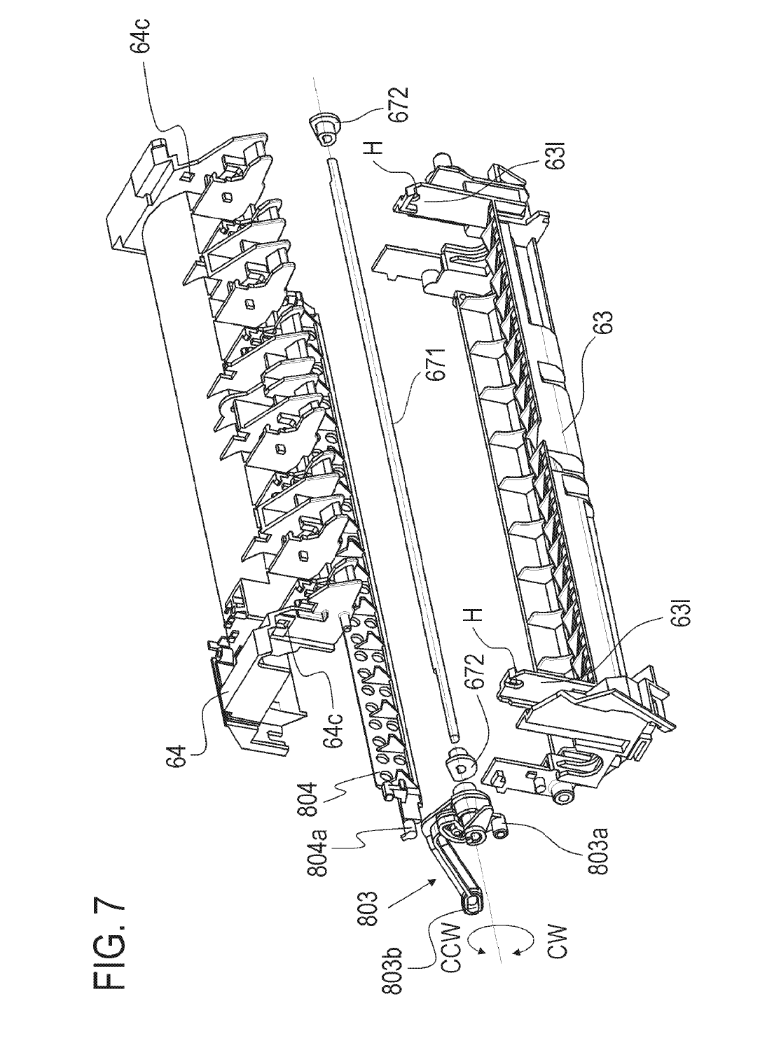

FIG. 7 is an exploded perspective view of the fixing unit 6. As illustrated in FIG. 7, the camshaft 671 extends in the longitudinal direction. The camshaft 671 is made of, for example, metal. The cam 672 is fixed to each end portion of the camshaft 671 in the axial direction. The cam 672 pivots as the camshaft 671 pivots. The lower frame 63 includes a support portion 63l configured to support the camshaft 671 in a pivotable manner. The support portion 63l is disposed at each of one end portion and the other end portion of the lower frame 63 in the longitudinal direction. The support portion 63l has a hole H for supporting the camshaft 671 in a pivotable manner.

The upper frame 64 has a groove 64c for supporting the camshaft 671 in a pivotable manner. The groove 64c is disposed at each of one end portion and the other end portion of the upper frame 64 in the longitudinal direction. The camshaft 671 is held between the upper frame 64 and the lower frame 63.

The camshaft 671 is supported to be pivotable. The cam 672 is capable of pressing the pressure arm 652 against the biasing force of the pressure spring 653.

### Fixing Shutter

The fixing unit 6 includes a fixing shutter 804 as illustrated in FIG. 7. This is for preventing an electric shock or a burn of a user, or an image defect due to contamination, which may occur when the user accesses the nip portion NP1 formed by the heating unit 61 and the pressure rotating member 62.

The fixing shutter 804 is configured basically such that the fixing shutter 804 is configured together with a shutter link 803. The shutter link 803 is supported coaxially with the camshaft 671 so as to rotate integrally with the camshaft 671 and the cam 672.

The fixing shutter 804 is supported to be swingable relative to the fixing unit 6, and a shutter shaft 804a is engaged with a link hole 803b of the shutter link 803. The shutter link 803 may be configured by one component or by assembling a plurality of components.

The operation of switching the states of the pressure release mechanism 67 and the fixing shutter 804 described above is interlocked with an opening/closing operation of the opening/closing door 21. The interlock with the opening/closing door 21 is achieved by coupling the opening/closing door 21 to a link shaft 803a by an intermediate link (not shown), for example. In interlock with a pivoting operation of the opening/closing door 21, the shutter link 803 and the cam 672 rotate in a CW direction or a CCW direction integrally with the camshaft 671.

When the opening/closing door 21 is in the closed state, through the link mechanism described above, the fixing unit 6 takes the pressurized state (first state) illustrated in FIG. 6A, and the fixing shutter 804 takes a released position. Meanwhile, when the opening/closing door 21 is in the open state, through the link mechanism described above, the fixing unit 6 takes the pressure-released state (second state) illustrated in FIG. 6B, and the fixing shutter 804 takes a shielding position.

### Heater Wiring

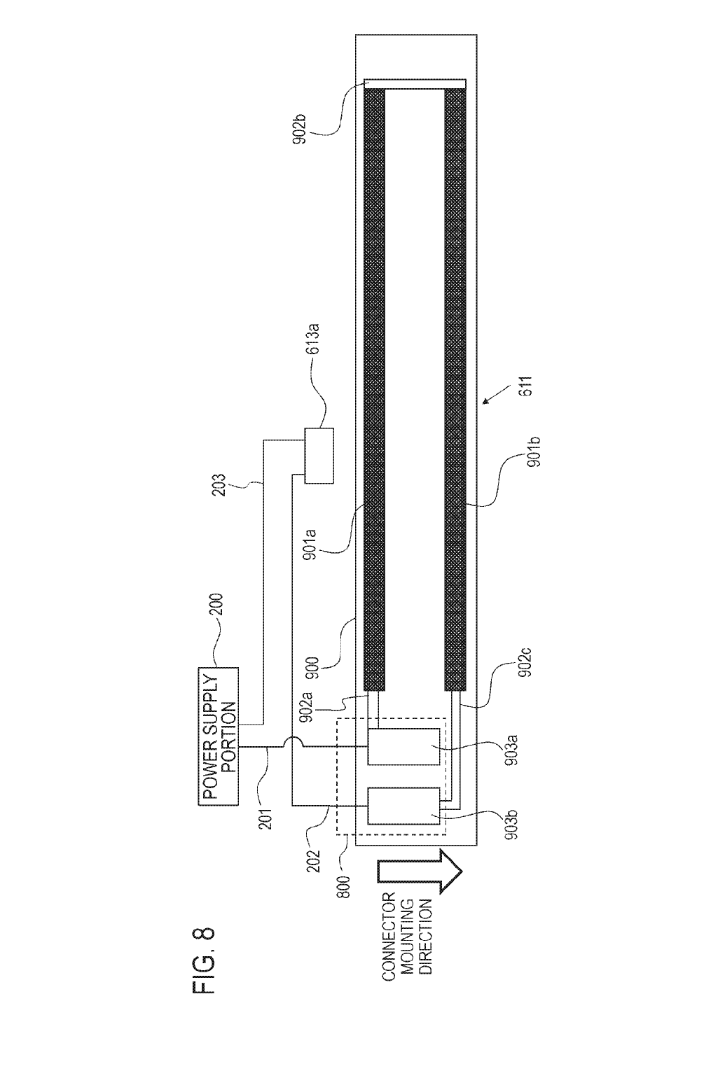

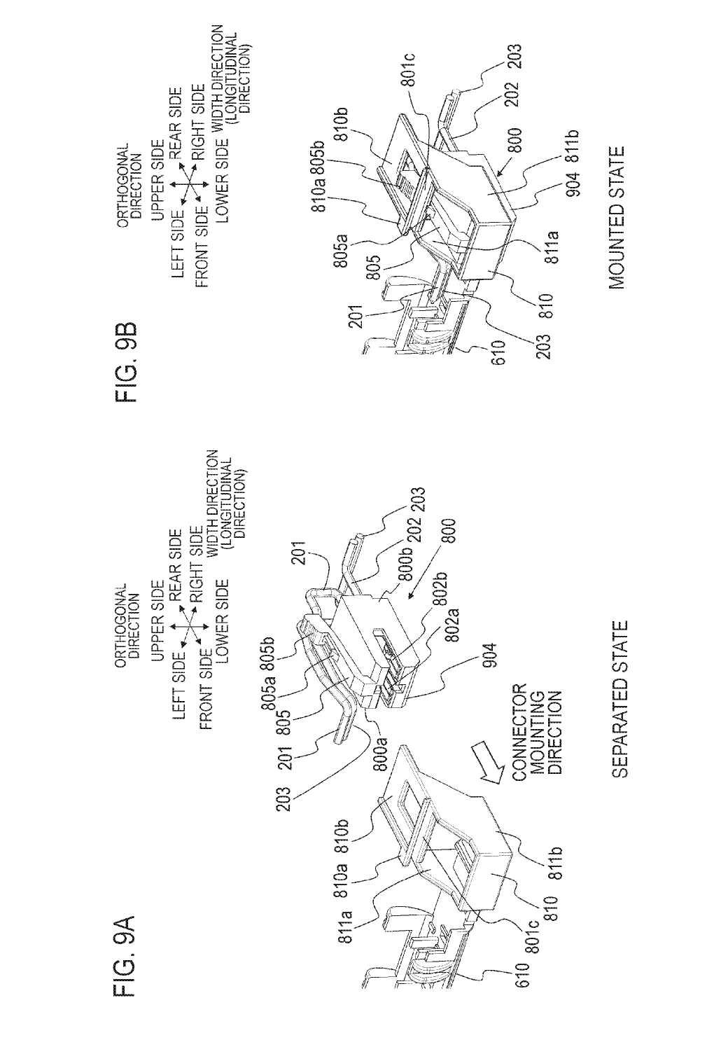

FIG. 8 is a schematic diagram illustrating a layout of heater electrodes. FIG. 9A is a perspective view of a heater connector in a pressure-released state. FIG. 9B is a perspective view of the heater connector in a mounted state. As illustrated in FIGS. 8, 9A, and 9B, in the structure of the heater 611, heat generating resistors 901a and 901b, which are provided along the longitudinal direction of a plate-shaped substrate 900, extend, and conductors 902a to 902c are connected correspondingly to both end portions of the two heat generating resistors 901a and 901b.

The conductor 902a has one end connected to an electrode 903a for a heat generating resistor, and the other end connected to the heat generating resistor 901a. The conductor 902b has one end connected to the heat generating resistor 901a, and the other end connected to the heat generating resistor 901b. The conductor 902c has one end connected to the heat generating resistor 901b, and the other end connected to an electrode 903b for a heat generating resistor. Thus, there is provided a heater circuit configuration in which when electric power is supplied between the electrodes 903a and 903b for the heat generating resistors, the heat generating resistors 901a and 901b simultaneously generate heat.

Electric power is supplied to the heater 611 by a heater connector (hereinafter simply referred to as "connector") 800 and cables 201 to 203, which serve as power supply cables, connected to the connector 800. The cable 201 connects the connector 800 to the power supply portion 200. The cable 202 connects the connector 800 to a thermostat 613a. Furthermore, the cable 203 connects the thermostat 613a to the power supply portion 200. The thermostat 613a is a switch configured to interrupt a circuit when its own temperature exceeds a threshold. When the heater 611 reaches a temperature higher than a certain threshold for any reason, the thermostat 613a is activated to interrupt the circuit between the heater 611 and the power supply portion 200. This prevents the temperature of the heater 611 from rising beyond the threshold.

### Description of Connector

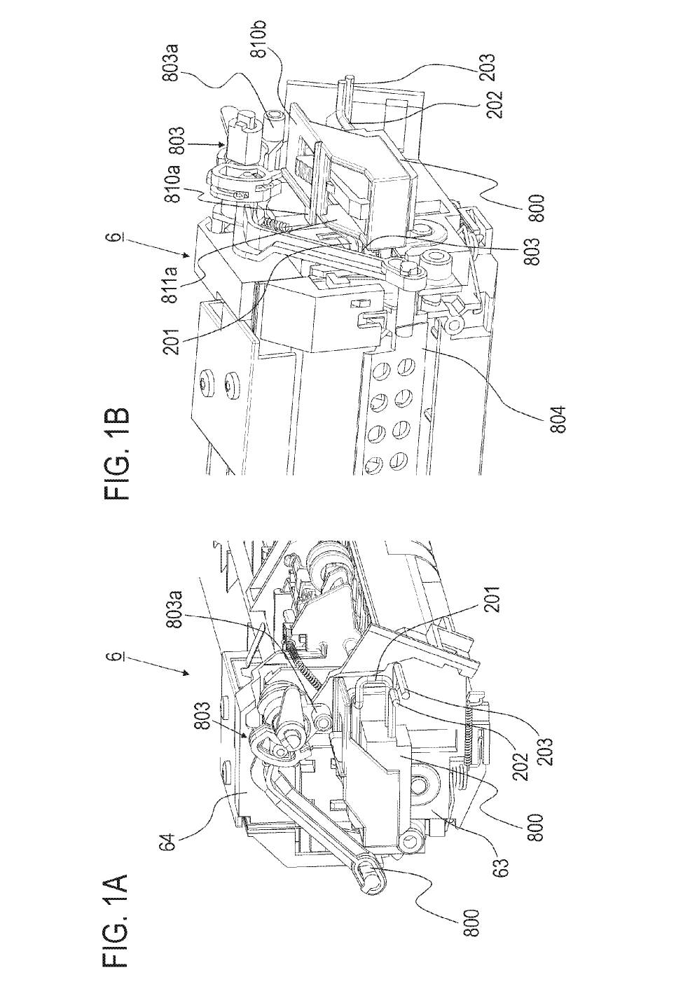

FIG. 1A is a perspective view of the fixing unit 6. FIG. 1B is a perspective view of the fixing unit 6. As illustrated in FIGS. 1A, 1B, 9A, and 9B, the connector 800 is mounted on one end portion of the holder 610 in the longitudinal direction from one side toward the other side of the heater 611 in the lateral direction. The connector 800 is a power supply connector for supplying electric power to the heater 611. The connector 800 is mounted on the holder 610 so as to sandwich the holder 610 and the heater 611, and is connected to the heater 611.

The connector 800 includes a housing 904 and an arm portion 805 produced from a non-conductive material such as resin, and contacts 802a and 802b made of a conductive material such as metal. The holder 610 has a connector cover 810 integrally molded with one end portion of the holder 610 in the longitudinal direction, for accommodating the connector 800 (see FIG. 5). When the connector 800 is inserted into the connector cover 810 in the connector mounting direction, the connector 800 can be accommodated in the connector cover 810 and thus mounted on the holder 610. In the present embodiment, the connector 800 is configured to be attachable to and detachable from the connector cover 810 in a direction that intersects with both the longitudinal direction of the heater 611 and a direction perpendicular to the planar portions (first surface 611a and second surface 611b) of the heater 611. Note that the attachment/detachment direction of the connector 800 with respect to the connector cover 810 is not limited to the above-mentioned direction.

In the mounted state, the connector 800 is mounted such that the position of the connector 800 in the width direction falls between a first side wall 811a and a second side wall 811b of the connector cover 810. The width direction of the connector 800 is a direction along the longitudinal direction of the heater 611. The connector 800 has a first side surface 800a and a second side surface 800b that intersect with the width direction. The first side surface 800a is one end surface of the connector 800 in the width direction of the connector 800, and faces the first side wall 811a (first wall portion) of the connector cover 810 in the state in which the connector 800 is accommodated in the connector cover 810. Furthermore, the second side surface 800b is the other end surface of the connector 800 in the width direction of the connector 800, and faces the second side wall 811b (second wall portion) of the connector cover 810 in the state in which the connector 800 is accommodated in the connector cover 810.

When the connector 800 is mounted on the holder 610 so as to be accommodated in the connector cover 810, the contact 802a and the electrode 903a (see FIG. 8) come into contact with the contact 802b and the electrode 903b (see FIG. 8), respectively. This makes it possible to supply electric power from the power supply portion 200 to the heat generating resistors 901a and 901b through the electrodes 903a and 903b.

Furthermore, the arm portion 805 includes a protruding portion 805a and a to-be-pressed portion 805b. In the mounted state, the protruding portion 805a has a role of a stopper for preventing the connector 800 from coming off the connector cover 810 by overlapping with a stopper rib 801c in the orthogonal direction (the attachment/detachment direction of the connector 800 with respect to the connector cover 810). When it is desired to remove the connector 800 from the connector cover 810, the connector 800 is moved rearward while pressing the to-be-pressed portion 805b downward. As the entire arm portion 805 elastically deforms downward, the overlap between the protruding portion 805a and the stopper rib 801c is released.

### Protection Form for Cables

As illustrated in FIGS. 9A and 9B, the connector cover 810 includes overhangs 810a and 810b for protecting the cables 201 to 203 from being pinched. The connector 800 and the cables 201 to 203 are disposed below the shutter link 803 that is a movable portion. Between the cables 201 to 203 and the shutter link 803, the overhangs 810a and 810b, which extend from the connector cover 810, are located. The overhangs 810a and 810b have a role of separating the shutter link 803 from the cables 201 to 203 in the up-down direction to prevent the cables 201 to 203 from being caught by a pivoting operation of the shutter link 803 and broken.

The overhangs 810a and 810b are extension portions integrally provided to the connector cover 810 so as to overlap with each of the cables 201 to 203 and the shutter link 803 when viewed from the direction perpendicular to the first surface 611a or the second surface 611b, which are the planar portions of the heater 611. The overhang 810a is a first extension portion that extends toward a side closer to the heater holder 610 than the first side wall 811a (first wall portion) is in the longitudinal direction of the heater 611. The overhang 810b is a second extension portion that extends toward an upstream side in the mounting direction of the connector 800 with respect to the connector cover 810, relative to the rear end of the connector 800 in the mounting direction.

The overhang 810a extends leftward beyond the first side wall 811a to enter the space between the cables 201 and 203, which are mainly routed on the left side of the connector 800, and the shutter link 803, which is the movable portion, thereby protecting the cables 201 and 203. The overhang 810b extends rearward beyond the connector 800 to enter the space between the regions of the cables 201 to 203 located on the rear side of the connector 800 and the shutter link 803, which is the movable portion, thereby protecting the cables 201 to 203.

In the present embodiment, the overhang 810a takes a rib shape that extends leftward from the connector cover 810, and the overhang 810b takes a rib shape that extends rearward from the connector cover 810, but the shapes of the overhangs 810a and 810b are not limited to these.

According to the present embodiment, it becomes possible to restrict an approach of the cables 201 to 203 to the pressure release mechanism 67 with a simple and inexpensive configuration. This makes it possible to avoid a risk that the cables 201 to 203 approach the shutter link 803, which is the movable portion of the fixing unit 6, and get pinched.

### Embodiment 2

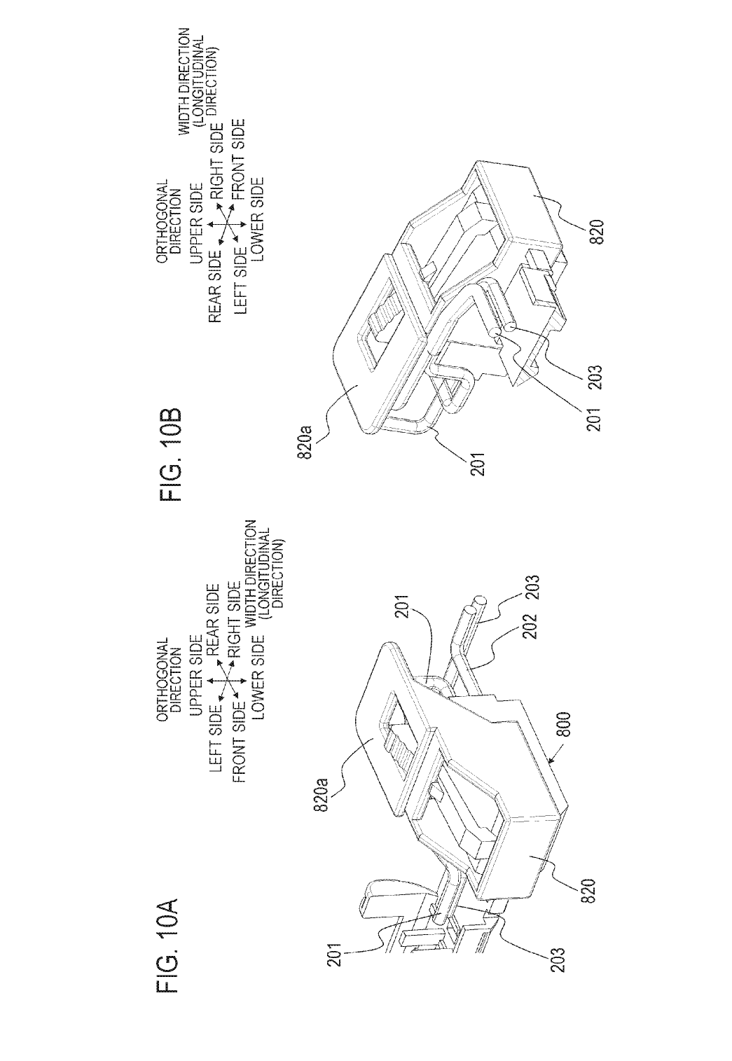

A configuration in which the cables 201 to 203 are separated from the shutter link 803 by a form different from the overhang forms described above is described using FIGS. 10A and 10B. FIGS. 10A and 10B are perspective views of a heater holder of Embodiment 2. In Embodiment 2, the matters not specifically described here are similar to those in Embodiment 1, and descriptions thereof are omitted.

In Embodiment 1, the plurality of overhangs is provided to protect the cables, but a configuration in which the cables on the left side and the rear side of the connector 800 are protected by an integral form such as an overhang 820a is also possible.

### Embodiment 3

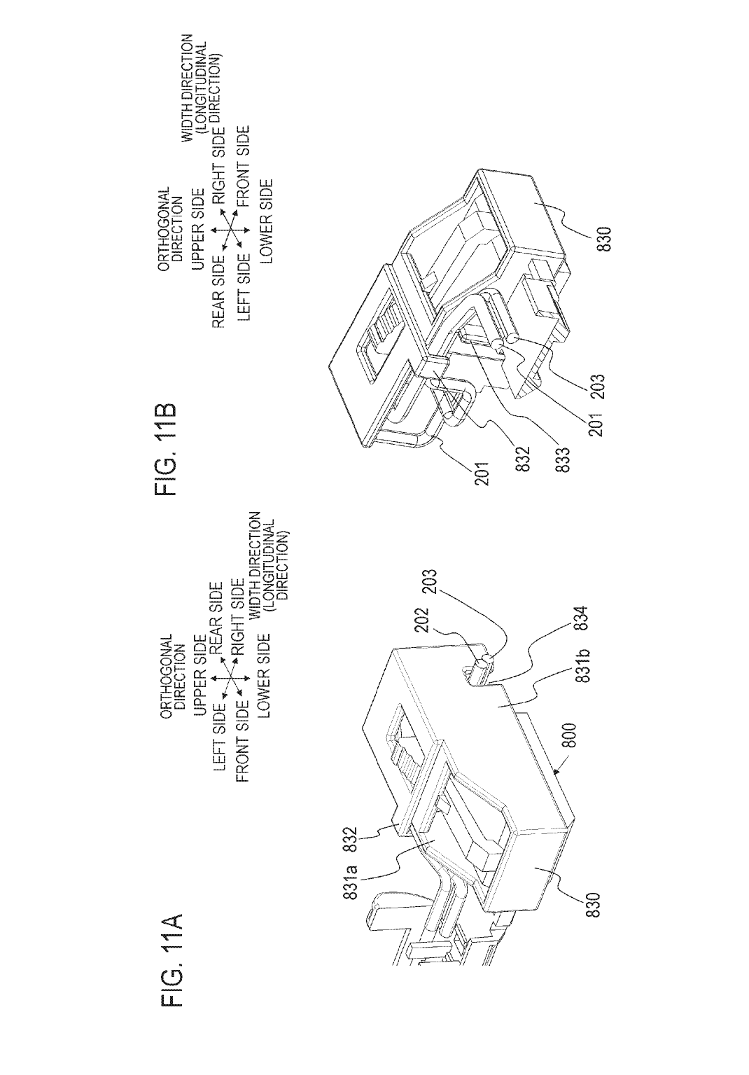

Furthermore, the means for separating the cables 201 to 203 from the shutter link 803 is not limited only to extending ribs from the top surface of a connector cover 830. As illustrated in FIGS. 11A and 11B, a cable holding form may be provided in the side surface of the connector cover 830. FIGS. 11A and 11B are perspective views of a heater holder of Embodiment 3. In Embodiment 3, the matters not specifically described here are similar to those in Embodiment 1 or 2, and descriptions thereof are omitted.

The connector cover 830 has a first side wall 831a and a second side wall 831b that extend in a direction that intersects with the longitudinal direction of the heater 611. The second side wall 831b is located to be farther from the heater holder 610 than the first side wall 831a is in the longitudinal direction of the heater 611. The second side wall 831b has a slit 834 having an opening on the lower side, as a slit portion for enabling the cables 202 and 203 to be locked. The slit portion is obtained by cutting out a part of the second side wall 831b. The cables 202 and 203 routed on the right side of the connector 800 are prevented from approaching the shutter link 803 by being accommodated in the slit 834.

Regarding the cables 201 and 203 routed on the left side of the connector 800, movement of the cables 201 and 203 is restricted by a hook 832 and a restriction rib 833. The hook 832 is provided on the left side of the first side wall 831a, that is, on a side that is closer to the heater holder 610 than the first side wall 831a is in the longitudinal direction of the heater 611. The hook 832 includes a first extension portion that extends in the longitudinal direction and a locking portion that extends from the distal end of the extension portion in question while being bent in a downward direction that is a direction that intersects with the longitudinal direction. The hook 832 is configured to be able to hold the cables 201 and 203 by sandwiching the cables 201 and 203 between the hook 832 and the first side wall 831a. The cables 201 and 203 are locked to the hook 832, thereby preventing the cables 201 and 203 from moving upward to approach the shutter link 803. Furthermore, the restriction rib 833 is provided to prevent the cables 201 and 203 from easily coming off the hook 832.

The respective configurations of the above-mentioned embodiments can be combined with each other.

According to the present disclosure, it is possible to restrict an approach of the cable to the pressure change mechanism with a simple configuration.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-002925, filed on January 8, 2025, which is hereby incorporated by reference herein in its entirety.

What is claimed is:

1. A fixing device comprising:
a fixing belt, which is cylindrical;
a heater, which is plate-shaped and disposed in an interior space of the fixing belt;
a heater holder disposed in the interior space of the fixing belt and configured to hold the heater over a longitudinal direction of the heater;
a power supply connector for supplying electric power to the heater, the power supply connector being connected to the heater so as to sandwich the heater holder and the heater;
a pressure roller configured to come into contact with an outer peripheral surface of the fixing belt, the pressure roller sandwiching the fixing belt together with the heater, thereby forming a fixing nip portion between the pressure roller and the fixing belt; and
a pressure change mechanism capable of switching between a first state in which a pressure applied to the fixing nip portion is high and a second state in which the pressure is low,
wherein in the fixing nip portion, a toner image formed on a recording material while conveying the recording material is fixed to the recording material,
wherein the heater holder has a connector cover integrally molded therewith and configured to accommodate the power supply connector, and
wherein the connector cover includes an extension portion that enters a space between a power supply cable that extends from the power supply connector and a movable portion of the pressure change mechanism, the extension portion overlapping with the power supply cable and the movable portion in a case of viewing from a direction perpendicular to a planar portion of the heater.

2. The fixing device according to claim 1,
wherein the connector cover has a first wall portion and a second wall portion that intersect with the longitudinal direction,
wherein the power supply connector has a first side surface that faces the first wall portion, and a second side surface that faces the second wall portion, and
wherein in a case where the power supply connector is mounted on the heater, the power supply connector is located between the first wall portion and the second wall portion of the connector cover.

3. The fixing device according to claim 2,
wherein the connector cover is provided at one end of the heater holder in the longitudinal direction,
wherein the second wall portion is located to be farther from the heater holder than the first wall portion is in the longitudinal direction, and
wherein the extension portion includes a first extension portion that extends toward a side closer to the heater holder than the first wall portion is in the longitudinal direction.

4. The fixing device according to claim 3,
wherein the extension portion includes a second extension portion that extends further toward an upstream side of the power supply connector in a mounting direction of the power supply connector to be mounted onto the connector cover than a rear end of the power supply connector in the mounting direction.

5. The fixing device according to claim 3,
wherein the first extension portion includes a locking portion that extends while being bent in a direction that intersects with the longitudinal direction so as to sandwich the power supply connector between the locking portion and the first wall portion.

6. A fixing device comprising:
a fixing belt, which is cylindrical;
a heater, which is plate-shaped and disposed in an interior space of the fixing belt;
a heater holder disposed in the interior space of the fixing belt and configured to hold the heater over a longitudinal direction of the heater;
a power supply connector for supplying electric power to the heater, the power supply connector being connected to the heater so as to sandwich the heater holder and the heater;
a pressure roller configured to come into contact with an outer peripheral surface of the fixing belt, the pressure roller sandwiching the fixing belt together with the heater, thereby forming a fixing nip portion between the pressure roller and the fixing belt; and
a pressure change mechanism capable of switching between a first state in which a pressure applied to the fixing nip portion is high and a second state in which the pressure is low,
wherein in the fixing nip portion, a toner image formed on a recording material while conveying the recording material is fixed to the recording material,
wherein the heater holder has a connector cover integrally molded therewith and configured to accommodate the power supply connector,
wherein the connector cover includes a holding form for holding a power supply cable that extends from the power supply connector, and
wherein the holding form holds the power supply cable so as to restrict movement of the power supply cable in a direction approaching a movable portion of the pressure change mechanism.

7. The fixing device according to claim 6,
wherein the connector cover has a first wall portion and a second wall portion that intersect with the longitudinal direction,
wherein the power supply connector has a first side surface that faces the first wall portion, and a second side surface that faces the second wall portion, and
wherein in a case where the power supply connector is mounted on the heater, the power supply connector is located between the first wall portion and the second wall portion of the connector cover.

8. The fixing device according to claim 7,
wherein the connector cover is provided at one end of the heater holder in the longitudinal direction,
wherein the second wall portion is located to be farther from the heater holder than the first wall portion is in the longitudinal direction, and
wherein the holding form includes a locking portion configured to hold the power supply connector so as to sandwich the power supply connector between the locking portion and the first wall portion, on a side that is closer to the heater holder than the first wall portion is in the longitudinal direction.

9. The fixing device according to claim 8,
wherein the holding form has a slit portion for enabling the power supply cable to be locked, the slit portion being obtained by cutting out a part of the second wall portion.

10. The fixing device according to claim 1,
wherein the power supply connector is attachable to and detachable from the connector cover in a direction that intersects with both the longitudinal direction and a direction perpendicular to a planar portion of the heater.

11. An image forming apparatus forming an image on a recording material, the apparatus comprising:
an image forming portion configured to form an unfixed image on the recording material;
a fixing portion configured to fix the unfixed image onto the recording material; and
a door configured to be movable between an open position at which an interior of the image forming apparatus is opened to an outside, and a closed position at which the interior is closed,
wherein the fixing portion is the fixing device of claim 1, and
wherein the pressure change mechanism is a link mechanism coupled to the door, the link mechanism comprising a mechanism capable of performing an operation of switching between the first state and the second state of the pressure change mechanism in interlock with an opening/closing operation of the door.
